(19) United States
(12) Patent Application Publication
(10) Pub. No.: US 2008/0108396 A1
(43) Pub. Date: May 8, 2008

(54) Wireless communications terminals that selectively power radio communications components

(76) Inventor: Sara Maria Lundqvist, Lund (SE)

Correspondence Address: MYERS BIGEL SIBLEY & SAJOVEC, P.A., P.O. BOX 37428, RALEIGH, NC, 27627, US

(21) Appl. No.: 11/600,496

(22) Filed: Nov. 16, 2006

Related U.S. Application Data
(60) Provisional application No. 60/864,038, filed on Nov. 2, 2006.

(51) Int. Cl. H04B 1/38

(52) U.S. Cl. 455/574

(57) ABSTRACT

A wireless communications terminal includes a radio communications component, a non-radio communications component, a battery, and a power controller. The radio communications component is configured to transmit/receive RF signals through a wireless air interface to carry out radio communications functionality with a separate wireless communications device. The non-radio communications component is configured to carry out non-radio communications functionality. The power controller is configured to supply power from the battery to the non-radio communications component while selectively preventing power from flowing to a least a portion of the radio communications component in response to a remaining power level in the battery being below a threshold reserve power level.

### CROSS-REFERENCE TO RELATED APPLICATION

This application claims priority to U.S. Provisional Patent Application No. 60/864,038, filed on Nov. 2, 2006, the disclosure of which is hereby incorporated herein by reference in its entirety.

### FIELD OF THE INVENTION

The present invention relates to wireless communication terminals, and more particularly relates to controlling communications functionality and non-communications functionality therein.

### BACKGROUND

There has been a continuing proliferation in the number and types of functionalities incorporated into wireless communications terminals. Wireless communications terminals have been introduced that have cellular telephone, pager, and messaging communication functionality along with still/video picture recording functionality, music player/recorder functionality, and personal digital assistant (PDA) functionality for managing contacts and calendar scheduling. The terminals can be configured to communicate with cellular communications networks, wireless routers (e.g., WLAN wireless access points), and/or with other wireless communications terminals through ad-hoc communications networks (e.g., Bluetooth network). The terminals may also be configured to allow users to, for example, carry out phone calls, manage appointment scheduling in a calendar, manage contact information, send and receive email/instant messages, record pictures/video, and/or access the Internet and the information available thereon.

Another trend with wireless communication terminals is to increase their portability by reducing their physical dimensions and by increasing the amount of time they can be powered between battery charging cycles. The increasing proliferation of functionality in terminals and associated increased processing and communications circuitry associated therewith can increase the operational power requirements of the terminals. Additionally, a desire to reduce the physical dimensions of terminals may necessitate the use of a smaller (typically less powerful) batteries. Accordingly, designers may be increasingly challenged when attempting to provide more functionality is yet smaller terminals while providing sufficient operational time between battery charging cycles.

### SUMMARY

Some embodiments of the present invention are directed to a wireless communications terminal that selectively powers a radio communications component therein. The wireless communications terminal includes a radio communications component, a non-radio communications component, a battery, and a power controller. The radio communications component is configured to transmit/receive RF signals through a wireless air interface to carry out radio communications functionality with a separate wireless communications device. The non-radio communications component is configured to carry out non-radio communications functionality. The power controller is configured to supply power from the battery to the non-radio communications component while selectively preventing power from flowing to a least a portion of the radio communications component in response to a remaining power level in the battery being below a threshold reserve power level.

The non-radio communications component can include a camera sensor and a camera controller configured to process images captured by the camera sensor. The power controller can supply power from the battery to the camera sensor and to the camera controller while selectively preventing power from flowing from the battery to at least a portion of the radio communications component in response to a remaining power level in the battery being below the threshold reserve power level.

The terminal can further include a camera window shutter that can be opened and closed to selectively expose the camera sensor to incident light, and an actuation sensor that is configured to generate an activation signal in response to opening of the camera window shutter. In response to a remaining power level in the battery being below the threshold reserve power level and in response to the activation signal indicating that the camera window shutter is open, the power controller can be configured to supply power to the camera controller and to the camera sensor while preventing power from being supplied to at least a portion of the radio communications component.

The non-radio communications component can include a music/voice player/recorder controller and/or an email/messaging controller, and the power controller can be further configured to supply power from the battery to the music/voice player/recorder controller and/or to the email/messaging controller while selectively preventing power from flowing from the battery to at least a portion of the radio communications component in response to a remaining power level in the battery being below the threshold reserve power level.

The power controller can be further configured to measure the remaining power level in the battery, to supply power to the radio communications component and to the non-radio communications component while the measured remaining power level is above the threshold reserve power level, and to cease supplying power to at least a portion of the radio communications component while continuing to supply power to the non-radio communications component when the measured remaining power level falls below the threshold reserve power level.

The radio communications component can be configured to carry out a cellular telephone call, and the wireless communication terminal can include a user interface that can be manipulated by a user to define the threshold reserve power level as a user defined minimum number of minutes of cellular telephone call talk time for which the battery is expected to have a sufficient power reserve to complete. The user interface may alternatively be used to define the threshold reserve power level as a user defined percentage of full battery power.

In response to a user turning-on the wireless communications terminal, the power controller can be further configured to measure the remaining power level in the battery, to begin supplying power to the radio communications component and to the non-radio communications component when the measure remaining power level is above the threshold reserve power level, and to prevent power from being supplied to at least a portion of the radio communications component while beginning to supply power to the non-radio communications component when the measured remaining power level is below the threshold reserve power level.

The wireless communications terminal can further include an internal memory and a removable memory module. The radio communications component can be configured to read/write data in the internal memory. The power controller can be configured to selectively prevent power from flowing from the battery to the internal memory while allowing power to flow to the removable memory module in response to the remaining power level in the battery being below the threshold reserve power level. The non-radio communications component can be configured to selectively read/write data to/from: 1) the internal memory when the internal memory is powered on, or 2) the removable memory module when the internal memory is powered off.

The non-radio communications component can include a camera sensor and a camera controller, a music/voice player/recorder controller, and/or an email/messaging controller one or more of which can be configured to selectively read/write data to/from: 1) the internal memory when the internal memory is powered on, or 2) the removable memory module when the internal memory is powered off.

In some other embodiments of the present invention, the wireless communications terminal includes a radio communications component, a non-radio communications component, a battery, an actuation sensor, and a power controller. The actuation sensor is configured to generate an activation signal in response to sensing physical actuation of a component of the wireless communications terminal. The power controller is configured to supply power from the battery to the non-radio communications component while selectively preventing power from flowing to at least a portion of the radio communications component in response to the activation signal.

The wireless mutations terminal can further include a camera sensor and a camera window shutter. The actuation sensor generates the activation signal in response to opening of the camera window shutter. The non-radio communications component can include a camera controller that is configured to process images captured by the camera sensor. In response to a user turning-on the wireless communications terminal, the power controller can be configured to selectively: 1) begin supplying power to the camera controller while preventing power from being supplied to at least a portion of the radio communications component in response to the activation signal indicating that the camera window shutter is open, or 2) begin supplying power to the radio communications component while leaving the camera controller powered off in response to the activation signal indicating that the camera window shutter is closed.

When the wireless communications terminal is powered off, the power controller can be configured to respond to the activation signal indicating that the camera window shutter is open by beginning to supply power to the camera controller and to the camera sensor while leaving at least a portion of the radio communications component powered off.

The actuation sensor can include a camera button and associated electrical switch which, when actuated, generates the activation signal. When the wireless communications terminal is powered off, the power controller can be configured to respond to the activation signal caused by user actuation of the camera button by beginning to supply power to the camera controller and to the camera sensor while leaving at least a portion of the radio communications component powered off.

The wireless communications terminal can further include first and second housing portions that are connected together by a hinge that allows the first and second housing portions to be moved between an open position and a closed position. The actuation sensor can be configured to generate the activation signal in response to opening of the first and second housing portions from the closed position. The power controller can be configured to supply power from the battery to the camera controller and to the camera sensor while leaving at least a portion of the radio communications component powered off in response to the activation signal from the actuation sensor indicating that the first and second housing portions have been opened from the closed position.

The non-radio communications component can include a music/voice player/recorder controller that is configured to allow a user to receive recorded music/voice through the radio communications component while the radio communications component is powered on, and to allow a user to play/record music/voice but not allow a user to receive recorded music/voice while the radio communications component is not powered on. The power controller can be configured to supply power from the battery to the music/voice player/recorder controller while leaving at least a portion of the radio communications component powered off in response to the activation signal from the actuation sensor indicating that the first and second housing portions have been opened from the closed position.

The non-radio communications component can include an email/messaging controller that is configured to allow a user to transmit and receive email/messages through the radio communications component while the radio communications component is powered on, and to allow a user to create and review email/messages but not allow a user to transmit or receive email/messages while the radio communications component is not powered on. The power controller can be configured to supply power from the battery to the music/voice player/recorder controller while leaving at least a portion of the radio communications component powered off in response to the activation signal from the actuation sensor indicating that the first and second housing portions have been opened from the closed position.

### BRIEF DESCRIPTION OF THE DRAWINGS

FIG. 1 is a schematic diagram illustrating a wireless communication system that includes a wireless communications terminal incorporating radio communications functionality and non-radio communications functionality configured in accordance with some embodiments of the present invention.

FIG. 2 illustrates an exemplary camera window shutter on the wireless communications terminal of FIG. 1.

FIG. 3 is a block diagram illustrating in more detail the wireless communications terminal of FIG. 1 in accordance with some embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” and abbreviation “/” include any and all combinations of one or more of the associated listed items.

As used herein, a “wireless communications terminal” may include cellular or other wireless communications capabilities, may combine voice and/or data communications capabilities; Personal Digital Assistants (PDAs) that include a radio frequency transmitter/receiver, Internet/Intranet access, Web browser, organizer, calendar and/or a global positioning system (GPS) receiver; and/or other terminals that include a radio frequency (RF) transceiver configured to establish a wide/local-area network connection for voice/data transmission.

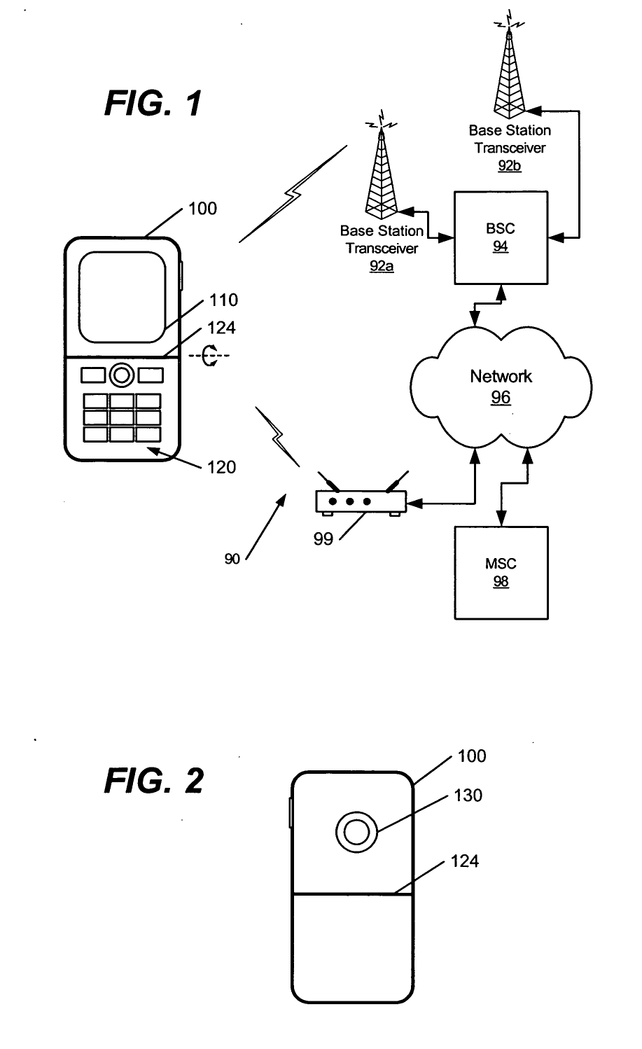

Embodiments of the present invention will now be described with reference to FIGS. 1-3. FIG. 1 is a schematic diagram that illustrates a wireless communications terminal 100 that provides radio communications functionality for communicating with a wireless communications network 90 over a RF communication interface. The wireless communications network 90, for example, may include a plurality of base station transceivers 92a-b, a base station controller (BSC) 94, a wireline network 96 (e.g., private/public (Internet) network), and a mobile switching center 98. Alternatively, the network 90 may include a wireless local/wide area network router 99, such as a wireless router (wireless access point) that operates according to one or more of the IEEE 802.11 wireless communication standards. Accordingly, the radio communications functionality may include, but is not limited to carrying out radio telephone calls (e.g., cellular calls, Voice Over IP calls), wireless e-mail/messaging, wirelessly accessing data content through the network 96.

The wireless communications terminal 100 may include a display 110 and a keypad interface 120, and may include a foldable housing (e.g., a clamshell housing) which can pivot about a hinge 124 between an open position and a closed position. The wireless communications terminal 100 is configured to provide a variety of non-radio communications functionality for use by a user. The non-radio communications functionality may include, but is not limited to, digital camera functionality, music/voice player/recorder functionality, e-mail/messaging functionality, and/or calendar/appointment functionality.

When the wireless mutations terminal 100 includes digital camera functionality, the terminal 100 may further include a camera window shutter which can be opened and closed to selectively expose a camera sensor to incident light. FIG. 2 illustrates an exemplary camera window shutter 130 on the wireless communications terminal 100 of FIG. 1 that may be opened and closed by user actuation of the shutter 130 and/or in response to activation/deactivation of the camera functionality within the terminal 100.

In some embodiments of the present invention, the wireless communications terminal 100 is configured to enable one or more of the non-radio communications functionalities to be utilized while the radio communications functionality remains powered off. Accordingly, the user may be able to conserve battery power while using the non-radio communications functionality by maintaining at least a portion of the radio communications functionality powered off, and/or the user may be able to more quickly start up and utilize the non-radio communications functionality.

In sharp contrast, it is understood that before non-radio communications functionality, such as a camera, can be utilized on conventional cellular radio telephones, the radio communications functionality must also be powered up and then complete a communications registration process with a wireless communications network. The communications registration process can include searching within defined frequency ranges for one or more control channels from a compatible wireless communications network, communicating subscriber information from the phone through a selected control channel to the wireless communications network, and receiving authorization and control information from the wireless communications network and responding thereto. As can be appreciated in light of the embodiments of the invention disclosed herein, when a user desires to only utilize non-radio communications functionality in a wireless mutations terminal, providing power to the radio communications functionality while completing the communications registration process may unnecessarily consume power and delay access by a user to the non-radio communications functionality.

In some embodiments of the present invention, a non-radio communications component, such as a digital camera, a music/voice player/recorder, an e-mail/messaging, and/or a calendar/appointment can be powered-on and utilized while at least a portion of a radio communications component remains powered off or power thereto is turned off. Moreover, in some embodiments, the wireless communications terminal 100 may monitor remaining battery power level and, when the remaining power level falls below a threshold reserve power level, may power off and/or maintain off at least a portion of the radio communications component (e.g., prevent use of the radio communications functionality) while allowing continued use of one or more non-radio communications components.

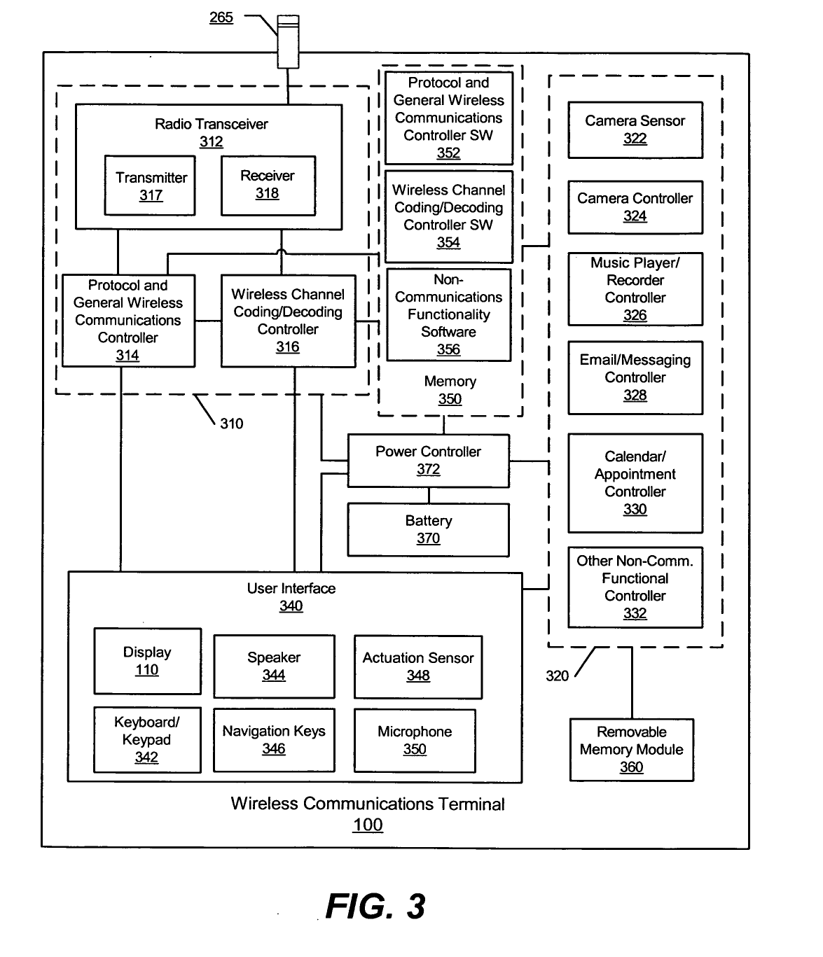

Further exemplary embodiments of the present invention will now be described with reference to FIG. 3, which is a block diagram illustrating further exemplary detail of the wireless communications terminal 100 of FIG. 1. Referring to FIG. 3, the wireless communications terminal 100 may include a radio communications component 310, a non-radio communications component 320, a user interface 340, a memory 350 (i.e., an internal memory), a removable memory module 360, a battery 370, and a power controller 372. Although the power controller 372 has been illustrated as being separate from the radio communications component 310 and the non-radio communications component 320 for convenience of reference, it is to be understood that its functionality described herein may be integrated into one or more of the other illustrated functional blocks and/or another functional block.

The radio communications component 310 may include a radio transceiver 312, a protocol and general wireless communications controller 314, and a wireless channel coding/decoding controller 316. The radio transceiver 312 may include a RF transmitter circuit 317 and a RF receiver circuit 318 to allow bi-directional communications with the base station transceivers 92a-b, however the present invention is not limited thereto, and, as used herein, a “transceiver” may include only a RF transmitter or only a RF receiver. The protocol and general wireless communications controller 314 may include, for example, a general-purpose processor that is configured to execute software 352 in the memory 350 to carry out a defined communications protocol to register and communicate with the wireless communications network 90. The protocol and general wireless communications controller 314, for example, may be configured to communicate according to one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). The wireless channel coding/decoding controller 316, for example, may include a digital signal processor that is configured to execute software 354 in the memory 350 to encode/decode information, such as voice and/or data, that is to be communicated to and/or received from the wireless communications network 90.

Although separate functional blocks have been illustrated for the radio transceiver 312, the protocol and general wireless communications controller 314, and the wireless channel coding/decoding controller 316, the software 352, and software 354, it is to be understood that their associated functionality may be integrated within one or more common integrated circuits.

The user interface 340 may include the display 110, the keyboard/keypad 342, a speaker 344, navigation keys 346, a housing actuation sensor 348, and/or a microphone 350. The actuation sensor 348 may be configured to generate an activation signal in response to sensing physical actuation of a component of the wireless communications terminal 100. The actuation sensor 348, for example, may detect opening/closing of the terminal 100 housing by a user pivoting upper and lower portions of the terminal 100 housing about the hinge 124, may detect opening/closing of the camera window shutter 130, and/or may detect physical actuation of a button and associated electrical switch, such as part of the keypad 342. The actuation sensor 348 may, for example, include a mechanically actuated switch and/or a magnetically actuated switch (e.g., a magnet attached to one movable portion of the housing and a magnetically actuated switch attached to another movable portion of the housing).

The non-radio communications component 320 may include a camera sensor 322, a camera controller 324, a music/voice player/recorder controller 326, an e-mail/messaging controller 328, a calendar/appointment controller 330, and/or another non-communications functional controller 332. The camera controller 324 can be configured to process images, such as digital still pictures and/or video, captured by the camera sensor 322 and record the processed images into the memory 250 and/or into the removable memory module 360. The music/voice player/recorder controller 326 may be configured to play music, such as MP3 music, which may be downloaded from the wireless communications network 90, recorded through the microphone 350, and/or otherwise stored in the memory 250 and/or in the removable memory module 360. The e-mail/messaging controller 328 may be configured to allow a user to generate e-mail/messages (e.g., short messaging services messages and/or instant messages) for present transmission to the wireless communications network 90, and/or to generate and store e-mail/messages off-line (e.g., while communications are not established between the wireless communications terminal 100 and the network 90) for later communication to the wireless communications network 90 upon connection thereto. The calendar/appointment controller 330 may provide a calendar that can be viewed by a user and/or may enable a user to schedule appointments associated with calendar dates and times.

Although separate functional blocks have been illustrated for the camera sensor 322, the camera controller 324, the music/voice player/recorder controller 326, the e-mail/messaging controller 328, the calendar/appointment controller 330, and the other non-communications functional controller 332, it is to be understood that some or all of their associated functionality may be integrated within one or more common integrated circuits. The non-radio communications component 320, for example, may be carried out by a general/special purpose processor that executes software instructions 356 resident in the memory 350.

In some embodiments, a user may cause at least a portion of the non-radio communications component 320 to be powered-on and made available for use while at least a portion of the radio communications component 310 remains power off. A user may cause the non-radio communications component 320 to be powered on in response to an activation signal from the actuation sensor 348 by opening a housing of the wireless communications terminal 100 and/or by actuation of one or more defined buttons (e.g., hardware/software buttons and associated electrical switches) in the interfaces 342 and/or 346. In response to the activation signal, the power controller 372 may selectively provide power from the battery 370 to selected function portions of the non-radio communication component 320 while at least a portion of the radio communications component 310 remains powered off or is powered off.

The power controller 372 may maintain/power off the radio communications component 310 by at least substantially preventing power from flowing from the battery 370 to the radio transceiver 312, to the protocol and general wireless communications controller 314, and/or to the wireless channel coding/decoding controller 316.

The power controller 372 may power-on the camera sensor 322 and the camera controller 324 in response to a user opening the camera shutter 130 and may power-on the memory 350 and/or the removable memory module 360 to enable pictures/video to be recorded therein. The power controller 372 can maintain at least a portion of the radio communications component 310 powered off while selectively powering the camera sensor 322 and the camera controller 324.

In an exemplary embodiment, in response to a user turning-on the wireless communications terminal 100, the power controller 372 is configured to begin supplying power to the camera sensor 322 and the camera controller 324 while preventing power from being supplied to at least a portion of the radio communications component 310 in response to the activation signal indicating that the camera window shutter 130 is open, and to begin supplying power to the radio communications component 310 while leaving the camera sensor 322 and the camera controller 324 powered off in response to the activation signal indicating that the camera window shutter 130 is closed.

In another embodiment, the wireless communication terminal 100 can include a camera button and associated electrical switch (e.g., as part of the user interface 340). When the wireless communications terminal is powered off, the power controller 372 can be configured to respond to the activation signal caused by actuation of the camera button by beginning to supply power to the camera controller 324 and to the camera sensor 322 while leaving at least a portion of the radio communications component 310 powered off. Similarly, when the wireless communications terminal is powered off, the power controller 372 can be configured to respond to the activation signal caused by opening of the housing of the terminal 100 by beginning to supply power to the camera controller 324 and to the camera sensor 322 while leaving at least a portion of the radio communications component 310 powered off (e.g., opening the terminal 100 housing turns on the camera functionality).

The power controller 372 may selectively power-on the music/voice player/recorder controller 326, the e-mail/messaging controller 328, the calendar/appointment controller 330, and/or the other non-communications functionality controller 332 in response to a user opening of the housing of the terminal 100 and/or actuation of one or more defined buttons (e.g., hardware/software buttons/switches) in the interfaces 342 and/or 346, while maintaining at least a portion of the radio communications component 310 powered off.

The music/voice player/recorder controller 326 may be configured to allow a user to receive recorded music/voice through the radio communications component 310 from the wireless communication network 90 while the radio communications component 130 is powered on, and to allow a user to play/record music/voice but not allow a user to receive recorded music/voice while the radio communications component 130 is not powered on. The email/messaging controller 328 may be configured to allow a user to transmit and receive email/messages through the radio communications component 130 from the wireless communication network 90 while the radio communications component 130 is powered on, and to allow a user to create and review email/messages off-line (for later transmission) while the radio communications component 130 is not powered on. The power controller 372 may be configured to supply power from the battery 370 to the music/voice player/recorder controller 326 and/or to the email/messaging controller 328 while leaving at least a portion of the radio communications component 130 powered off in response to the activation signal from the actuation sensor 348 indicating that wireless communication terminal 100 has been opened (e.g., first and second housing portions have been opened from the closed position).

In some further embodiments, the power controller 372 is configured to supply power from the battery 370 to the non-radio communications component 320 while selectively preventing power from flowing to at least a portion of the radio communications component 310 in response to a remaining power level in the battery 370 being below a threshold reserve power level. The power controller 372 may measure power in the battery 370 (e.g., by measuring/estimating expended battery power). The power controller 372 may determine when the remaining power in the battery 370 falls below the threshold reserve power level, and may respond to that determination by powering down at least a portion of the radio communications component 310.

The threshold reserve power level may be a value that is defined by a manufacturer and/or may be a variable value that can be controlled by a user through the user interface 340. The threshold reserve power level may be defined based on a percentage level of a fully charged power level of the battery 370 (e.g., the threshold reserve power level can be 4% of the fully charged battery power level), and/or may be defined based on a measurement and/or estimation of how much talk time may be provided by the remaining power in the battery 370 (e.g., the threshold reserve power level can be 5 minutes of remaining talk time capacity).

The power controller 372 may power off at least a portion of the radio communications component 310 in response to determining that the battery 370 now contains less than a defined threshold percentage of its full power level and/or that the battery 370 now has a remaining power level that is sufficient to provide less than a defined number of minutes of talk time for a telephone call (e.g., a cellular telephone call) between the wireless communications terminal 100 and the wireless communications network 90. The power controller 372 may thereby power down the radio transceiver 312 and the controllers 314 and 316 to reduce the power drain from the battery 370 and, thereby, reserve the remaining power in the battery 370 for continued use by at least a portion of the non-radio communication component 320.

Moreover, although the remaining power level in the battery 370 may be insufficient to power-on, or maintain on, the radio communications component 310 (which can have a relatively high power drain requirement) and other elements of the wireless communications terminal 100 so as to enable registration, call set up, and carrying out of a telephone call between the wireless communications terminal 100 and another communications device connected to the wireless communications network 90 for at least a sufficient length of time (e.g., for at least a few minutes), the remaining power level in the battery 370 may be sufficient to enable a much longer use of the non-radio communications component 320 (which can have a lower, or substantially lower, power requirement then the radio communications component 310).

As will be appreciated, the radio communications component 310 can include electrical components, such as the radio transceiver 312 and the controllers 314 and 316, which can have high current and associated power demands. By powering off the radio transceiver 312 and the controllers 314 and 316, the non-radio communication component 320 may continue to be available for utilization by a user for a longer period of time than may otherwise be provided if the radio communications component 310 were not powered down.

In an exemplary embodiment, in response to a remaining power level in the battery 370 being below the threshold reserve power level and in response to the activation signal indicating that the camera window shutter 130 is open, the power controller 372 may supply power to the camera controller 324 and to the camera sensor 322 while preventing power from being supplied to at least a portion of the radio communications component 310.

In another exemplary embodiment, in response to a user turning-on the wireless communications terminal 100, the power controller 372 may be configured to measure the remaining power level in the battery 370, to begin supplying power to the radio communications component 310 and to the non-radio communications component 320 when the measure remaining power level is above the threshold reserve power level, and to prevent power from being supplied to at least a portion of the radio communications component 310 while beginning to supply power to the non-radio communications component 320 when the measured remaining power level is below the threshold reserve power level.

The power controller 372 may also power down the memory 350 when the remaining power level in the battery 370 falls below the defined threshold. At least a portion of the non-radio communications component 320 may be configured to read/write data from/to the removable memory module 360 while the memory 350 is powered down. For example, the camera controller 324, the music/voice player/recorder controller 326, the email/messaging controller 328, and/or the calendar/appointment controller 330 may be configured to selectively read/write data to/from: 1) the memory 350 when the memory 350 is powered on, or 2) the removable memory module 360 when the memory 350 is powered off.

Powering down the memory 350 may further extend the remaining power in the battery 370 for use by the non-radio communications component 320. Moreover, by writing data from the non-radio communications component 320 to the removable memory module 360, a user may then remove the module 360 to access the data for use with other electronic devices, and can thereby avoid possibly needing to first charge the battery 370 to enable transfer of the data from the memory 350 to the removable memory module 360.

As used herein, the term “controller” can encompass digital logic circuits including, but not limited to, one or more gate arrays, software instruction execution circuits (e.g., a microprocessor), discrete logic circuit elements, and/or analog circuitry.

In the drawings and specification, there have been disclosed exemplary embodiments of the invention. Although specific terms are employed, they are used in a generic and descriptive sense only and not for purposes of limitation, the scope of the invention being defined by the following claims.

What is claimed is:

1. A wireless communications terminal, comprising:
a radio communications component that is configured to transmit/receive RF signals through a wireless air interface to carry out radio communications functionality with a separate wireless communications device;
a non-radio communications component that is configured to carry out non-radio communications functionality;
a battery; and
a power controller that is configured to supply power from the battery to the non-radio communications component while selectively preventing power from flowing to at least a portion of the radio communications component in response to a remaining power level in the battery being below a threshold reserve power level.

2. The wireless communications terminal of claim 1, wherein:
the non-radio communications component comprises a camera sensor and a camera controller configured to process images captured by the camera sensor; and
the power controller is further configured to supply power from the battery to the camera sensor and to the camera controller while selectively preventing power from flowing from the battery to at least a portion of the radio communications component in response to a remaining power level in the battery being below the threshold reserve power level.

3. The wireless communications terminal of claim 2, further comprising:
a camera window shutter that is configured to be opened and closed to selectively expose the camera sensor to incident light; and
an actuation sensor that is configured to generate an activation signal in response to opening of the camera window shutter,
wherein in response to a remaining power level in the battery being below the threshold reserve power level and in response to the activation signal indicating that the camera window shutter is open, the power controller is further configured to supply power to the camera controller and camera sensor while preventing power from being supplied to at least a portion of the radio communications component.

4. The wireless communications terminal of claim 1, wherein:
the non-radio communications component comprises a music/voice player/recorder controller and/or an email/messaging controller; and
the power controller is further configured to supply power from the battery to the music/voice player/recorder controller and/or to the email/messaging controller while selectively preventing power from flowing from the battery to at least a portion of the radio communications component in response to a remaining power level in the battery being below the threshold reserve power level.

5. The wireless communications terminal of claim 1, wherein:
the power controller is further configured to measure the remaining power level in the battery, to supply power to the radio communications component and to the non-radio communications component while the measured remaining power level is above the threshold reserve power level, and to cease supplying power to at least a portion of the radio communications component while continuing to supply power to the non-radio communications component when the measured remaining power level falls below the threshold reserve power level.

6. The wireless communications terminal of claim 5, wherein:
the radio communications component comprises:
a radio transceiver that is configured to transmit/receive RF signals;
a wireless channel coding/decoding controller that is configured to encode/decode information to be transmitted/received through the radio transceiver; and
a protocol communications controller that is configured to carry out a signaling protocol for communicating with another wireless communications device,
wherein the power controller is further configured to cease supplying power to at least the radio transceiver portion of the radio communications component while continuing to supply power to the non-radio communications component when the measured remaining power level falls below the threshold reserve power level.

7. The wireless communications terminal of claim 6, wherein:
the power controller is further configured to cease supplying power to the radio transceiver, the wireless channel coding/decoding controller, and the protocol communications controller while continuing to supply power to the non-radio communications component when the measured remaining power level falls below the threshold reserve power level.

8. The wireless communications terminal of claim 5, wherein the radio communications component is configured to carry out a cellular telephone call, and the wireless communication terminal further comprises a user interface that can be manipulated by a user to define the threshold reserve power level as a user defined minimum number of minutes of cellular telephone call talk time for which the battery is expected to have a sufficient power reserve to complete.

9. The wireless communications terminal of claim 8, wherein the power controller is further configured to cease supplying power to at least a portion of the radio communications component while continuing to supply power to the non-radio communications component when the remaining battery power becomes insufficient to carry out a cellular telephone call for at least the user defined minimum number of minutes.

10. The wireless communications terminal of claim 5, further comprising a user interface that can be manipulated by a user to define the threshold reserve power level as a user defined percentage of full battery power.

11. The wireless communications terminal of claim 5, wherein:
in response to a user turning-on the wireless communications terminal, the power controller is further configured to measure the remaining power level in the battery, to begin supplying power to the radio communications component and to the non-radio communications component when the measure remaining power level is above the threshold reserve power level, and to prevent power from being supplied to at least a portion of the radio communications component while beginning to supply power to the non-radio communications component when the measured remaining power level is below the threshold reserve power level.

12. The wireless communications terminal of claim 1, further comprising:
an internal memory, wherein the radio communications component is configured to read/write data in the internal memory; and
a removable memory module,
wherein the power controller is further configured to selectively prevent power from flowing from the battery to the internal memory while allowing power to flow to the removable memory module in response to the remaining power level in the battery being below the threshold reserve power level, and
wherein the non-radio communications component is configured to selectively read/write data to/from: 1) the internal memory when the internal memory is powered on, or 2) the removable memory module when the internal memory is powered off.

13. The wireless communications terminal of claim 11, wherein:
the non-radio communications component comprises a camera sensor and a camera controller, a music/voice player/recorder controller, and/or an email/messaging controller one or more of which is configured to selectively read/write data to/from: 1) the internal memory when the internal memory is powered on, or 2) the removable memory module when the internal memory is powered off.

14. A wireless communications terminal, comprising:
a radio communications component that is configured to transmit/receive RF signals through a wireless air interface to carry out radio communications functionality with a separate wireless communications device;
a non-radio communications component that is configured to carry out non-radio communications functionality;
a battery;
an actuation sensor that is configured to generate an activation signal in response to sensing physical actuation of a component of the wireless communications terminal;
a power controller that is configured to supply power from the battery to the non-radio communications component while selectively preventing power from flowing to at least a portion of the radio communications component in response to the activation signal.

15. The wireless communications terminal of claim 14, further comprising:
a camera sensor; and
a camera window shutter that is configured to be opened and closed to selectively expose the camera sensor to incident light,
wherein the actuation sensor is configured to generate the activation signal in response to opening of the camera window shutter,
wherein the non-radio communications component comprises a camera controller that is configured to process images captured by the camera sensor, and
wherein in response to a user turning-on the wireless communications terminal, the power controller is further configured to begin supplying power to the camera controller while preventing power from being supplied to at least a portion of the radio communications component in response to the activation signal indicating that the camera window shutter is open, and to begin supplying power to the radio communications component while leaving the camera controller powered off in response to the activation signal indicating that the camera window shutter is closed.

16. The wireless communications terminal of claim 14, further comprising:
a camera sensor; and
a camera window shutter that is configured to be opened and closed to selectively expose the camera sensor to incident light,
wherein the actuation sensor is configured to generate the activation signal in response to opening of the camera window shutter,
wherein the non-radio communications component comprises a camera controller that is configured to process images captured by the camera sensor, and
wherein, when the wireless communications terminal is powered off, the power controller is further configured to respond to the activation signal indicating that the camera window shutter is open by beginning to supply power to the camera controller and to the camera sensor while leaving at least a portion of the radio communications component powered off.

17. The wireless communications terminal of claim 14, further comprising:
a camera sensor,
wherein the non-radio communications component comprises a camera controller that is configured to process images captured by the camera sensor,
wherein the actuation sensor comprises a camera button and associated electrical switch which, when actuated, generates the activation signal, and
wherein, when the wireless communications terminal is powered off, the power controller is further configured to respond to the activation signal caused by actuation of the camera button by beginning to supply power to the camera controller and to the camera sensor while leaving at least a portion of the radio communications component powered off.

18. The wireless communications terminal of claim 14, further comprising:
a camera sensor;
first and second housing portions that are connected together by a hinge that allows the first and second housing portions to be moved between an open position in the closed position,
wherein the actuation sensor is further configured to generate the activation signal in response to opening of the first and second housing portions from the closed position,
wherein the non-radio communications component comprises a camera controller that is configured to process images captured by the camera sensor, and
the power controller is further configured to supply power from the battery to the camera controller and to the camera sensor while leaving at least a portion of the radio communications component powered off in response to the activation signal from the actuation sensor indicating that the first and second housing portions have been opened from the closed position.

19. The wireless communications terminal of claim 14, further comprising:
first and second housing portions that are connected together by a hinge that allows the first and second housing portions to be moved between an open position in the closed position,
wherein the actuation sensor is further configured to generate the activation signal in response to opening of the first and second housing portions from the closed position, and
wherein the non-radio communications component comprises a music/voice player/recorder controller that is configured to allow a user to receive recorded music/voice through the radio communications component while the radio communications component is powered on, and to allow a user to play/record music/voice but not allow a user to receive recorded music/voice while the radio communications component is not powered on, and
the power controller is further configured to supply power from the battery to the music/voice player/recorder controller while leaving at least a portion of the radio communications component powered off in response to the activation signal from the actuation sensor indicating that the first and second housing portions have been opened from the closed position.

20. The wireless communications terminal of claim 14, further comprising:
first and second housing portions that are connected together by a hinge that allows the first and second housing portions to be moved between an open position in the closed position,
wherein the actuation sensor is further configured to generate the activation signal in response to opening of the first and second housing portions from the closed position, and
wherein the non-radio communications component comprises an email/messaging controller that is configured to allow a user to transmit and receive email/messages through the radio communications component while the radio communications component is powered on, and to allow a user to create and review email/messages but not allow a user to transmit or receive email/messages while the radio communications component is not powered on, and
the power controller is further configured to supply power from the battery to the music/voice player/recorder controller while leaving at least a portion of the radio communications component powered off in response to the activation signal from the actuation sensor indicating that the first and second housing portions have been opened from the closed position.

21. The wireless communications terminal of claim 14, wherein:
the radio communications component comprises:
a radio transceiver that is configured to transmit/receive RF signals;
a wireless channel coding/decoding controller that is configured to encode/decode information to be transmitted/received through the radio transceiver; and
a protocol communications controller that is configured to carry out a signaling protocol for communicating with another wireless communications device,
wherein the power controller is further configured to cease supplying power to at least the radio transceiver portion of the radio communications component while continuing to supply power to the non-radio communications component in response to the activation signal.
